(19) United States
(12) Patent Application Publication
(10) Pub. No.: US 2017/0287344 A1
(43) Pub. Date: Oct. 5, 2017

(54) Multi-Skills Activity Center

(71) Applicant: Jessie M. Polk, Memphis, TN (US)

(72) Inventor: Jessie M. Polk, Memphis, TN (US)

(21) Appl. No.: 15/085,712

(22) Filed: Mar. 30, 2016

(51) Int. Cl. G09B 1/06; G09B 19/02; G09B 19/00

(52) U.S. Cl. CPC G09B 1/06; G09B 19/0061; G09B 19/02

(57) ABSTRACT

A teaching aid helps develop multiple skills in children in core curriculum areas such as mathematics, geography, and the like. The teaching aid that creates classroom activities without the use of pencil and paper and provides for activities to stay in place, until completed now or later. The teaching aid utilizes a multi-skill activity center.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to the field of the education, classroom teaching aids for children. The invention, particularly relates to teaching tools for children that, help develop and strengthen their knowledge of standard core curriculum skills such as social studies and mathematics, etc.

2. Description of Related Art Including Information Disclosed Under 37 CFR 1.97 And 37 CFR 1.98.

The inventor has a Masters of Education Degree in elementary education and classroom experiences using educational tools that lack improvement for maintaining skill performances. Nowadays, it has become increasingly difficult for teachers and parents to find effective, age-appropriate teaching aids for children. Most teaching aids currently on the market are found in one box, leaving the educators, parents, and other caregivers to buy multiple boxes of games and activities that are not compelling enough to engage children. Other aids that may be limited to only one topic or subject when boxed, can become repetitive and boring.

There may be a number of different types of teaching aids or tools that are available in prior art and found the market place. For example, see: U.S. patent application Ser. No. 13/025,243 to Jeffery; U.S. Pat. No. 6,626,675 to Sharon; U.S. Pat. No. 5,076,793 to Aghevli et al.; U.S. Pat. No. 5,571,019 to Dallas; U.S. Pat. No. 5,980,263 to Karen.

U.S. patent application Ser. No. 13/025,243 discloses a method of facilitating physical exercise and a better understanding of a subject category, comprising an interactive game for play by a number of persons; placing a device into a field of play by a first team, wherein the device provides to a second team a plurality of possible answers to a question and/or direction to be responded to by the second team; displaying around a periphery of the device a plurality of possible answers to the question; wherein placing the device into the field of play includes striking the device by a member of the first team for subsequent fielding of said device by the second team; and, wherein the member of the first team continually runs from one base to another base until at least the second team fields the device and answers the question.

Another prior art U.S. Pat. No. 6,626,675 discloses multiple activity apparatus for visual educational, recreational or therapeutic uses having plural, positionable utility panels which can be collapsed for convenient portability. The invention comprises three utility panels which include rectangular frame members joined at abutting ends in a triangular configuration having open triangular ends, a base frame and two upwardly converging side frames. A utility board is mounted in each respective frame member, each boards having an exterior work or display surface whereby a pair of upright utility panels is selectively positionable, with the remaining panel providing a base.

Another prior art U.S. Pat. No. 5,076,793 discloses fractal mathematics learning kit that includes a plurality of boards each in the shape of an equilateral triangle having defined thereon a pattern of ten smaller equilateral triangles, and a plurality of manipulative elements made of one or more connected equilateral triangles which are attached to the equilateral triangles defined on the boards. A set of tokens thick enough to stand on an edge and comprising combinations of equilateral triangles to represent numbers is also included. Also included in the kit is a mat defining rows and columns of fractal representations of numbers by which various mathematical operations can be understood.

Yet another prior art U.S. Pat. No. 5,571,019 discloses system for teaching the basic concepts of mathematics utilizing a ball or the like having situated thereon certain mathematical problems and solutions, each such problem having framed thereabout certain colored geometric symbols, the symbols indicating certain commonalities in the problem. The ball is to be utilized in organized or unorganized play, and is configured in such a manner so as to relay to the user certain basic themes associated with mathematics, including (but not limited to) addition, subtraction, multiplication, and division.

Yet another prior art U.S. Pat. No. 5,980,263 discloses a teaching apparatus comprises a three-dimensional geometrical object having a surface divided into a plurality of segments, each of which includes a question relating to a particular field of liberal arts study. The three-dimensional geometrical object is a sphere, and the plurality of segments is defined by visible lines provided on the sphere's surface.

It can be observed that the prior arts mentioned above provide an interactive way of teaching for only single topic or subject and none provide a multiple skill development for students with a multi-skills teaching aid or tool. Hence, there is a need in the art for a teaching aid that develops multiple skills in children while making it interesting and interactive. The present invention provides a multi-skill activity center for creative teachers, instructors or parents. The present invention presents multiple skills for the development of children's knowledge in core curriculum areas such as mathematics, geography, and the like.

### BRIEF SUMMARY OF THE INVENTION

In the view of the foregoing disadvantages inherent in the known types of teaching aids for teachers, instructors, and parents now present in the prior art, the present invention provides improved techniques for relating information, skills and knowledge to students. As such, the general purpose of the present invention, which will be described subsequently in greater detail, is to provide new and improved teaching aids or tools that have all the advantages of the prior art and none of the disadvantages. The present invention makes acquiring knowledge based information/skills fun.

An objective of the invention is to provide teaching aids that help develop multiple skills for children in core curriculum areas such as mathematics, geography, or the like.

It is another objective of the present invention to provide teaching aids that create classroom activities without the use of pencil and paper.

It is another objective of the present invention to provide teaching aids that provide for activities to stay in place, until completed.

It is another objective of the present invention to provide teaching aids that consist of the barbell shape made with the one-wrap fabric that overlaps end to end.

It is another objective of the present invention to provide multi-skills activities that are made with movable parts.

It is another objective of the present invention to provide multi-skills activities that comprise a plurality of barbell shaped pieces overlapping end to end.

It is another objective of the present invention to provide an activity center that is comprised of a plurality of circular shaped pieces, square shape pieces, octagon shape pieces, and triangular shaped pieces adapted for removably.

It is another objective of the present invention to provide an activity center that further comprises a plurality of figures of the seven continents.

It is yet another objective of the present invention to provide a hook or loop material that removably secures the geometrical shapes to a display board covered with loop fabric.

It is yet another objective of the present invention to provide multi-skills activity centers whose all parts are made with one-wrap hook and loop fabric.

It is another objective of the present invention to provide a display board for mounting the activities of the activity center.

Another objective of the center is to provide a board that is covered with adhesive loop fabric.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced, constructed, and carried out in various ways. Also, it is to be understood that the phraseology and terminology employed herein are for the purpose of description and should not be regarded as limiting.

These together with other objectives of the invention, along with the various features of novelty which characterizes the invention, are pointed out particularity in the disclosure. For a better understanding of the invention, its operating advantages and the specific objectives attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objectives other than those set forth above will become apparent when consideration is given to the following detailed description thereof. Such description makes reference to the annexed drawings wherein:

FIG. 1 shows the barbell-shaped drawing having One-wrap hook and loop material.

FIG. 2 shows a circular part having One-wrap hook and loop fabric that depicts the configuration for the top and bottom of the globe.

FIG. 3 shows a plurality of parts having different pictures and geometrical shapes for graphs.

FIG. 4 shows seven different continents of the world separated from each other.

FIG. 5 shows a plurality of numbers having a One-wrap hook and loop material.

FIG. 6 shows a plurality of letters having a One-wrap hook and loop material.

FIG. 7 shows a display board for attaching Banditlocks Multi-skills Activity Center activities.

FIG. 8 shows a globe for attaching banditlocks multi-skills activity center activities.

FIG. 9 shows a plurality of ships for the import export game.

### DETAILED DESCRIPTION OF THE INVENTION

In the following detailed description, reference is made to the accompanying drawings which form a part hereof, and in which is shown by way of illustration specific embodiments in which the invention may be constructed and practiced. These embodiments are described in sufficient detail to enable those skilled in the art to construct and practice the invention, and it is to be understood that the embodiments may be overlapped, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

A teaching aid for instructors that includes a multi-skills activity center which is made of a hook and loop fabric. The multi-skills activity center is a Banditlocks multi-skills activity center that consists of at least nine movable parts. The movable parts is configured to have a plurality of shapes and preferably, selected from a group of but not limited to, a flower shape, a barbell shape, an octagon shape, a square shape, an isosceles triangle, a circle and a combination thereof.

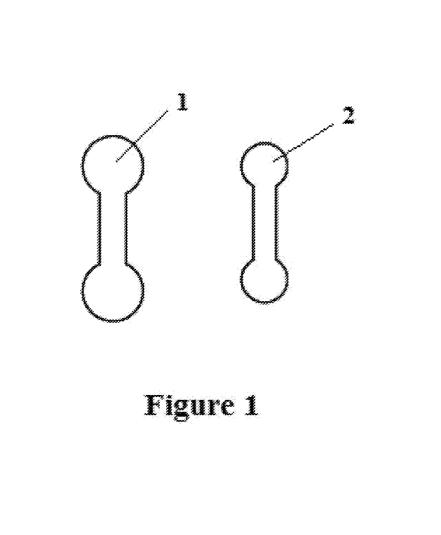

Referring to FIG. 1, shows the barbell-shaped drawing having a One-wrap hook and loop material of the present invention. Preferably, the drawing comes in two specific sizes, but not limited to, one size (1) is 2.63 inches from top to bottom and the other size (2) is 3.06 inches from top to bottom as shown in FIG. 1.

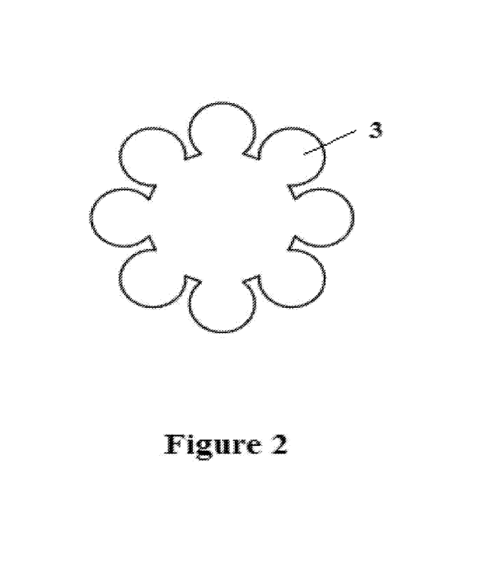

Another preferred embodiment of the invention that looks like a flower with eight or 8 petals (3) is shown in FIG. 2. The figure also shows a third part that is an octagon which is 1.423 inches side to side, a fourth part that is square, which is 1.216 inches and a fifth part that is an isosceles triangle, which is 1.511 inches at the base.

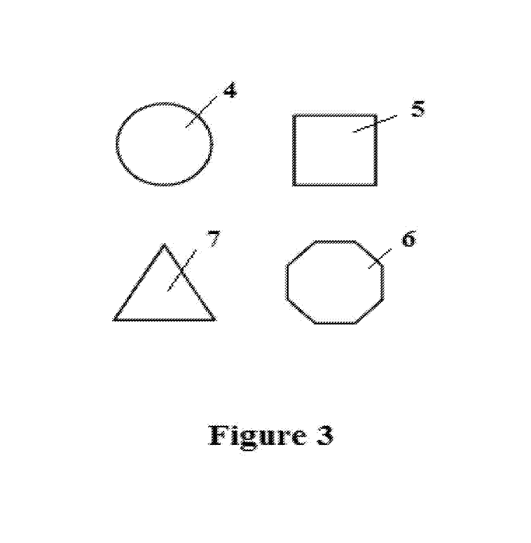

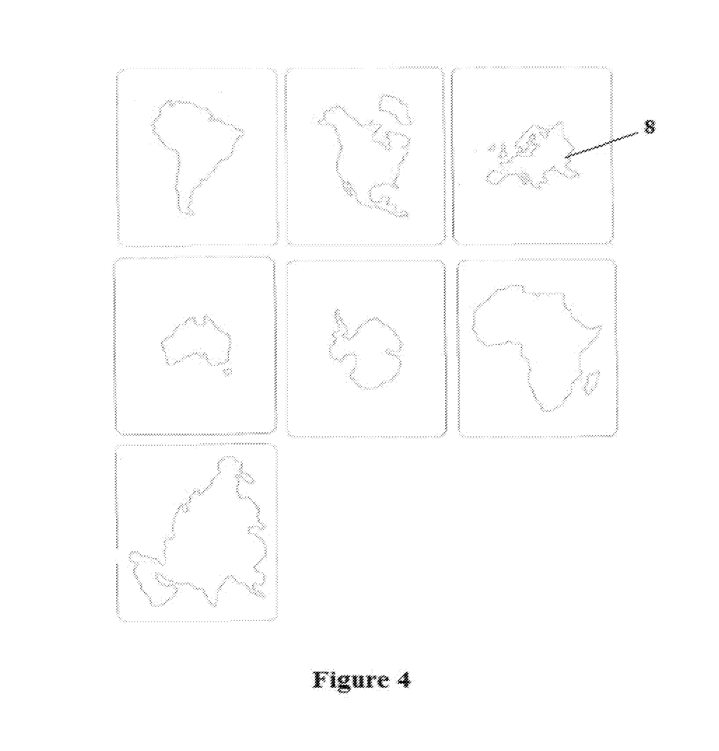

Referring to FIG. 3, showing a sixth part that is a circle (4) having a diameter 1.423 inches and other geometrical shapes like octagon (6), square (5) and isosceles triangle (7) having user defined dimensions. FIG. 4 shows the shapes of different continents (8) of the world.

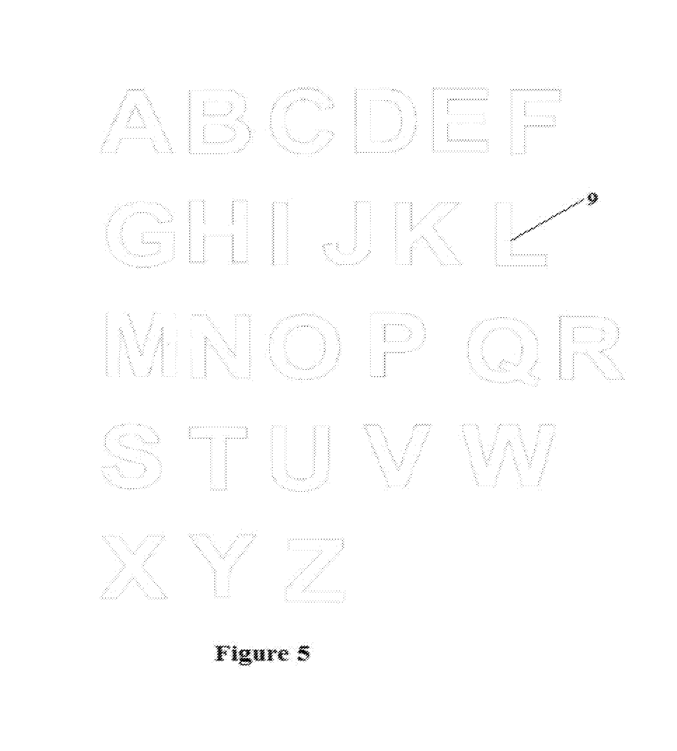

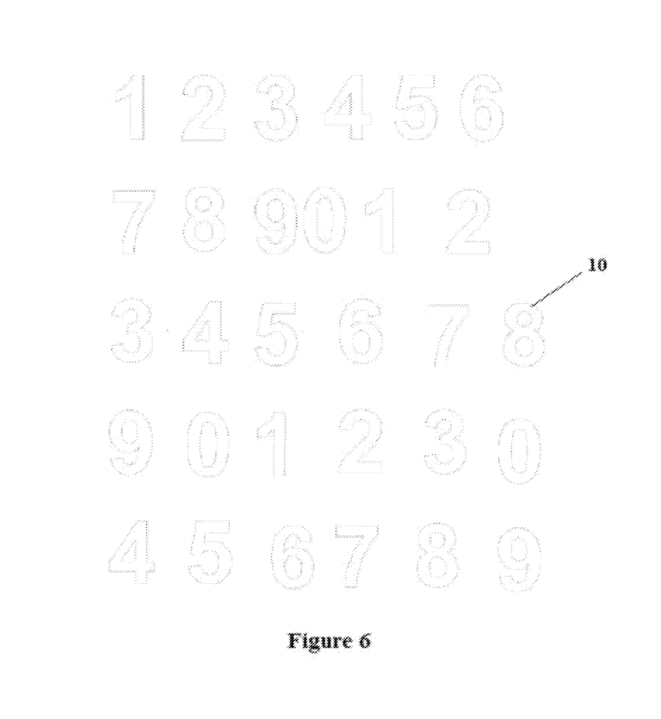

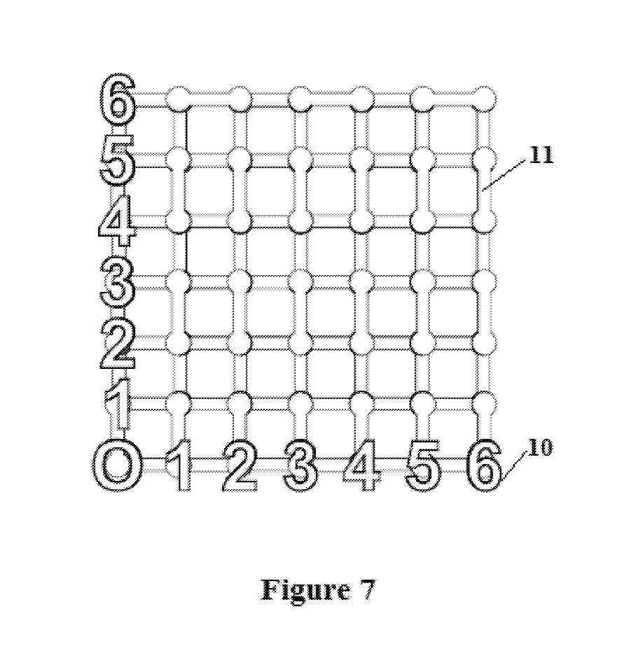

Further, FIG. 5, shows number of alphabets (9) and FIG. 6 shows numbers (10) made with One-wrap fabric which are used by children on a display board (11) shown in FIG. 7. The children perform various activities asked of them by the instructor or teacher; for example doing simple mathematics like addition, subtraction, division and multiplication, or the like with numbers and forming different words from the alphabets; for example cat, mat, rat or the like. Students are able to create their own ideas for concept learning and performances. The display board for the Banditlocks multi-skills activity center is folded from a corrugated board with dimensions of 18″ wide and 24″ in length. When folded the board is 18″ wide side to side and 12″ in height from top to bottom. The board is folded in the middle to make it look like a tent and to lend its two attached sides. One 18″×24″ side is covered with adhesive loop material folded to measure 18″×12″ to fit into a box having the dimensions of 14″ (fourteen inches breadth), and 20″, or (twenty inches in length).

The present invention enables instructors or parents to create one or more learning stations and allows students to use the learning stations to develop instructed learning activities of their own. The invention comprises multi-skill activity centers. The center features brightly colored letters, numerals, and other symbols, including barbell-shaped pieces that can be temporarily affixed end to end hook side overlapping loop side to a vertical surface of a contrasting color.

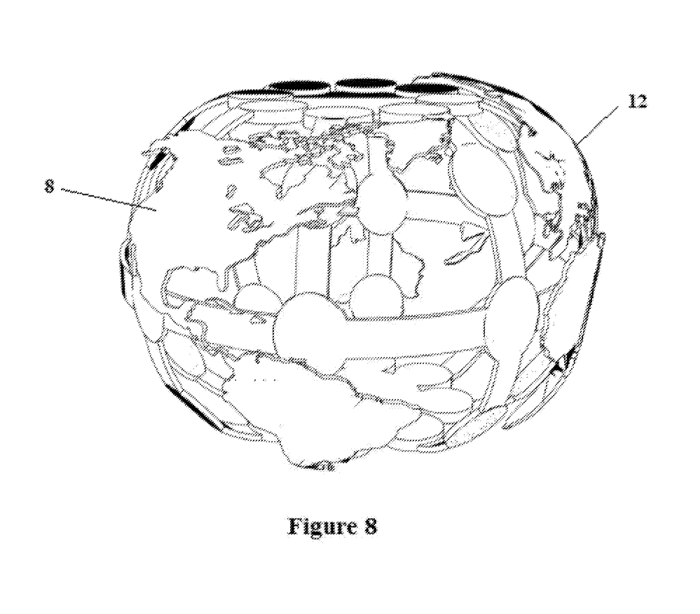

FIG. 8 shows a globe (12) for attaching banditlocks multi-skills activity center activities. The barbell pieces are attached end to end to the flowery piece and can overlap each other, end to end to create a globe. Further, the continent pieces (8) can be applied to the globe. The globe activity should have labels that name the continents, etc. In general, the nine or more symbols can be used by instructors or parents to create a broad assortment of visual aids for games and other activities that teach children the necessary skills for core curriculum subjects, used in nearly all states for the measurement of scholastic progress. Instructors and parents can also create their own games, questions to earn “X's” and “O's” or to advance runners around the diamond of a baseball field. The exact specifications may vary upon manufacturing.

In one embodiment, the present multi-skills activity center consists of at least nine movable parts. These parts include first part that looks like a flower with at least eight petals. This part is used in constructing a globe. Second part looks like a barbell. It comes in two specific sizes. For example, one size is 2.63 inches from top to bottom; another size is 3.06 inches from top to bottom. The third part is an octagon, for example 1.423 inches from side to side. The fourth part is a square, for example 1.216 inches. The fifth part is an isosceles triangle, for example 1.511 inches at the base. The sixth part is a circle, for example, has a diameter of 1.423 inches. These geometrical shapes are used with graphs. The other parts may consist of 1.5 inch numbers, letters, and ships. The current dimensions do not restrict the present invention.

In another embodiment, the multi-skill activity center comprises a plurality of barbell shaped pieces having an elongated center section with a circular section disposed on each end of the elongated center section. The circular sections of each barbell piece are removably attached end to end to circular sections of other barbell shaped sections.

In another embodiment, the multi-skill activity center comprises a plurality of circular shaped pieces adapted to removably attach to the barbell shaped pieces in order to form various shapes, such as globes, and solid geometrical shapes (pyramids, cubes, and spheres).

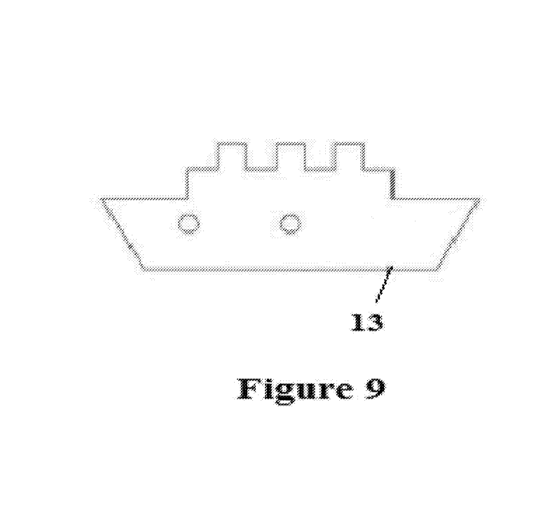

In yet another embodiment, the multi-skill activity center further comprises a plurality of figures, such as letters, numbers, continents, shapes, ships and the like. As shown in FIG. 9 plurality of ships (13) for the import export game. Each player will begin the game with seven to eight ships included in the game. The figures are removably attached end to end to the barbell shaped pieces to form lines of latitude and longitude. In operation, the figures, circular shaped pieces, and barbell shaped pieces are connected to one another and configured to create a visual aid for children, such as a grid. All parts are made with the one-wrap hook and loop fabric. The multi-skill activity center is a set linking one-wrap fabrics cut in a special design to create activities for classroom use by teachers and students. The banditlocks overlap each other, end to end to give the flexibility needed for creating an activity that is required by the student, or teacher.

It is to be understood that the above description is intended to be illustrative, and not restrictive. For example, the above-discussed embodiments may be used in combination with each other. Many other embodiments will be apparent to its use upon reviewing the above description for a specified skill.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A teaching aid for instructors, comprising:
a multi-skill activity center;
wherein said multi-skill activity center is made of a hook and loop fabric.

2. The teaching aid for instructors or like according to claim 1, wherein said multi-skill activity center consists of at least nine movable parts.

3. The teaching aid for instructors or like according to claim 2, wherein said movable parts are configured to have a plurality of shapes.

4. The teaching aid for instructors or like according to claim 3, wherein said plurality of shapes is selected from a group of a flower shape, a barbell shape, an octagon shape, a square shape, an isosceles triangle, a circle and a combination thereof.

5. The teaching aid for instructors or like according to claim 1, wherein said hook and loop fabric is a one-wrap structure.

6. The multi-skill activity center according to claim 2, wherein said multi-skill activity center further comprises:
a plurality of barbell shaped pieces;
a plurality of circular shaped pieces;
a plurality of figures;
a plurality of alphabets;
a plurality of numbers;
a display board; and
a plurality of ships.

7. The multi-skill activity center according to claim 6, wherein said plurality of barbell pieces is configured to have an elongated section with a circular section.

8. The multi-skill activity center according to claim 7, wherein said circular section is disposed on each end of the elongated section.

9. The multi-skill activity center according to claim 7, wherein said circular section of each barbell piece is a removably attached circular section of said barbell shaped section.

10. The multi-skill activity center according to claim 6, wherein said plurality of circular shaped pieces is adapted to removably attach to said plurality of barbell pieces.

11. The multi-skills activity center according to claim 6, wherein said plurality of circular shaped pieces is attached to a plurality of barbell pieces to form a plurality of geometrical shapes.

12. The multi-skill activity center according to claim 6, wherein said plurality of figures is selected from a group of letters, numbers, continents, shapes, ships and a combination thereof.

14. The multi-skill activity center according to claim 6, wherein said display board is made of corrugated plastic.
